(19) United States
(12) Patent Application Publication
(10) Pub. No.: US 2008/0252452 A1
(43) Pub. Date: Oct. 16, 2008

(54) Intruder detection system

(75) Inventor: Shuji Aizawa, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Tokyo (JP)

(21) Appl. No.: 11/907,053

(22) Filed: Oct. 9, 2007

(30) Foreign Application Priority Data
Apr. 10, 2007 (JP) 2007-103067

(51) Int. Cl. G08B 13/00

(52) U.S. Cl. 340/555; 340/541; 340/561

(57) ABSTRACT

An intruder detection system includes: an intruder detection device; and a leaky transmission line pair including a transmission-side leaky transmission line, which is connected to the intruder detection device and through which an electric wave is output on the basis of an output from the intruder detection device, and a receiving-side leaky transmission line, which is connected to the intruder detection device and through which the electric wave output from the transmission-side leaky transmission line is received. Intrusion detection is performed by causing the intruder detection device to detect a variation of the electric wave received through the receiving-side leaky transmission line. A plurality of leaky transmission line pairs, which are connected to the intruder detection device and through which the electric wave is output and received, are provided to be spaced apart from each other.

### BACKGROUND OF THE INVENTION

1. Field of the Invention

The present invention relates to an intruder detection system that includes an intruder detection device and a pair of leaky transmission lines including a transmission-side leaky transmission line, which is connected to the intruder detection device and through which a leaky electric wave is output on the basis of an output from the intruder detection device, and a receiving-side leaky transmission line, which is connected to the intruder detection device and through which the leaky electric wave output from the transmission-side leaky transmission line is received, and that performs intrusion detection by causing the intruder detection device to detect the change of an electric wave received in the receiving-side leaky transmission line.

2. Description of the Related Art

In a known intruder detection system using a security camera, a plurality of security cameras are used to detect the location of an intruder (refer to JP-A-04-177923 (FIG. 1 and corresponding description)).

Since the known intruder detection system is configured as described above, a detection range and a detection time should be set in accordance with the location of a security camera, the location of an image, or switching of the security camera. Accordingly, it is difficult to precisely set the detection range and a setting method is complicated. In addition, a plurality of security cameras are required for detection over a long distance or detection in a wide range of detection region having a complicated structure or shape. For this reason, the known intruder detection system is not suitable as a large-scale intrusion detection system that detects an intruder in a place such as a factory, a transformer substation, or an airport.

In view of the above situation, an intruder detection system based on a principle different from that disclosed in JP-A-04-177923 is under development in order to make it easy to detect whether or not an intruder is present and detect the intrusion location even in a large-scale intrusion detection system that detects an intruder in a place such as a factory, a transformer substation, or an airport.

An intruder detection system under development that has promoted the invention is configured as shown in FIG. 18.

Referring to FIG. 18, an intruder detection device 1 performs intrusion detection on an intruder or an intruding body by using leaky transmission lines 2-1 and 2-2. The intruder detection device 1 is configured to include a spread code generator 3, a receiving circuit 4, and an intrusion detection unit 5. The spread code generator 3 includes a spread code generating part 3a and a transmission circuit 3b.

An output of the transmission circuit 3b is a signal obtained by modulating a spread code with a high-frequency carrier wave and is output to the leaky transmission line 2-1. A leaky electric wave (not shown) is output through the leaky transmission line 2-1, the leaky electric wave is received through the leaky transmission line 2-2, and the received signal is received in the receiving circuit 4. In the receiving circuit 4, a phase operation on the received signal is performed using a reference spread code related to an intrusion distance and the electric field intensity is output to the intrusion detection unit 5. In the intrusion detection unit 5, the intrusion detection corresponding to the intrusion distance is performed on the basis of variation of the electric field intensity.

Hereinafter, the leaky transmission line 2-1 through which a leaky electric wave is output is referred to as a ‘transmission-side leaky transmission line 2-1’, the leaky transmission line 2-2 through which a leaky electric wave is received is referred to as a ‘receiving-side leaky transmission line 2-2’, and the leaky transmission lines 2-1 and 2-2 that form a pair are referred to as a ‘leaky transmission line pair 2-12’.

In the intrusion detection system under development in which the leaky transmission line pair 2-12 is used, it is known that the location of an intruder or intruding body can be detected over a detection range up to 600 m per intruder detection device 1. That is, due to attenuation of an electromagnetic wave in the transmission-side leaky transmission line 2-1 and the receiving-side leaky transmission line 2-2, the maximum length of each of the transmission-side leaky transmission line 2-1 and the receiving-side leaky transmission line 2-2 that allows desired intrusion detection to be performed is 600 m. In other words, the maximum length of the leaky transmission line pair 2-12 that allows the desired intrusion detection to be performed is 600 m.

Since the intrusion detection system under development is configured as described above, it is easy to detect whether or not an intruder is present and detect the intrusion location even in a large-scale intrusion detection system that detects an intruder and the like in a place such as a factory, a transformer substation, or an airport, compared with the intruder detection system disclosed in JP-A-04-177923. However, there has been a problem that detection cannot be performed in a detection range exceeding 600 m.

### SUMMARY OF THE INVENTION

The invention has been finalized in view of the above problems, and it is an object of the invention to provide an intruder detection system capable of extending a detection range more than 600 m and to extend an intrusion detection range.

According to an aspect of the invention, in an intruder detection system that includes the intruder detection device and the leaky transmission line pair including the transmission-side leaky transmission line, which is connected to the intruder detection device and through which a leaky electric wave is output on the basis of an output from the intruder detection device, and the receiving-side leaky transmission line, which is connected to the intruder detection device and through which the leaky electric wave output from the transmission-side leaky transmission line is received, and that performs intrusion detection by causing the intruder detection device to detect the variation of the leaky electric wave received through the receiving-side leaky transmission line, the plurality of leaky transmission line pairs, which are connected to the intruder detection device and through which the leaky electric wave is output and received, are provided to be spaced apart from each other, and accordingly, it is possible to extend an intrusion detection range.

The foregoing and other object, features, aspects, and advantages of the present invention will become apparent from the following detailed description of the present invention when taken in conjunction with the accompanying drawings.

### BRIEF DESCRIPTION OF THE DRAWINGS

FIG. 1 is a view illustrating a first embodiment of the invention, that is, a view illustrating an example of the basic system configuration;

FIG. 2 is a view illustrating the first embodiment of the invention, that is, a view illustrating an example of the concept of detection of the intrusion location;

FIG. 3 is a view illustrating the first embodiment of the invention, that is, a view illustrating a specific example of a transmission signal;

FIG. 4 is a view illustrating the first embodiment of the invention, that is, a block diagram illustrating an example of the inner configuration of an intruder detection device shown in FIG. 1;

FIG. 5 is a view illustrating the first embodiment of the invention, that is, a view illustrating an example of a detection table;

FIG. 6 is a view illustrating the first embodiment of the invention, that is, a view illustrating an example of an operation flow;

FIG. 7 is a view illustrating the first embodiment of the invention, that is, a view illustrating an example of the entire configuration of an intruder detection system in which a plurality of leaky transmission lines are connected to an intruder detection device;

FIG. 8A is a view illustrating the first embodiment of the invention, that is, a timing chart illustrating the timing alternately processed in the time division manner in order to allow signals of both an A-group leaky transmission line and a B-group leaky transmission line to be processed in the same spread code generator, receiving circuit, and intrusion detection unit;

FIG. 8B is a view illustrating the first embodiment of the invention, that is, a timing chart illustrating the timing alternately processed in the time division manner in order to allow signals of both an A-group leaky transmission line and a B-group leaky transmission line to be processed in the same spread code generator, receiving circuit, and intrusion detection unit;

FIG. 9 is a view illustrating a second embodiment of the invention, that is, a view illustrating another example of the entire configuration of an intruder detection system in which a plurality of leaky transmission line pairs are connected to an intruder detection device;

FIG. 10 is a view illustrating a third embodiment of the invention, that is, a view illustrating an example in which a transmission-side leaky transmission line and a receiving-side leaky transmission line each is configured to include a plurality of transmission lines;

FIG. 11 is a view illustrating the third embodiment of the invention, that is, a longitudinal sectional view illustrating a part of the detailed structure of an amplifying device shown in FIG. 10;

FIG. 12 is a view illustrating a fourth embodiment of the invention, that is, a view illustrating an example in which a plurality of leaky transmission line pairs are connected to an intruder detection device and a transmission-side leaky transmission line and a receiving-side leaky transmission line of each leaky transmission line pair are configured to include a plurality of transmission lines, respectively;

FIG. 13 is a view illustrating a fifth embodiment of the invention, that is, a view illustrating another example in which a transmission-side leaky transmission line and a receiving-side leaky transmission line each is configured to include a plurality of transmission lines, and in particular, an example in which power is supplied from an intruder detection device to an amplifying device;

FIG. 14 is a view illustrating a sixth embodiment of the invention, that is, a view illustrating still another example in which a transmission-side leaky transmission line and a receiving-side leaky transmission line each is configured to include a plurality of transmission lines, and in particular, another example in which power is supplied from an intruder detection device to an amplifying device;

FIG. 15 is a view illustrating a seventh embodiment of the invention, that is, a view illustrating still another example in which a transmission-side leaky transmission line and a receiving-side leaky transmission line each is configured to include a plurality of transmission lines, and in particular, an example in which a non-leaky transmission line is connected at the upstream side;

FIG. 16 is a view illustrating the seventh embodiment of the invention, that is, a longitudinal sectional view illustrating a part of the detailed structure in which each of a plurality of transmission lines shown in FIG. 15 is connected;

FIG. 17 is a view illustrating an eighth embodiment of the invention, that is, a view illustrating still another example in which a transmission-side leaky transmission line and a receiving-side leaky transmission line each is configured to include a plurality of transmission lines, and in particular, another example in which a non-leaky transmission line is connected at the upstream side; and

FIG. 18 is a view illustrating the configuration of an intruder detection system under development that has promoted the invention.

### DESCRIPTION OF THE PREFERRED EMBODIMENTS

### First Embodiment

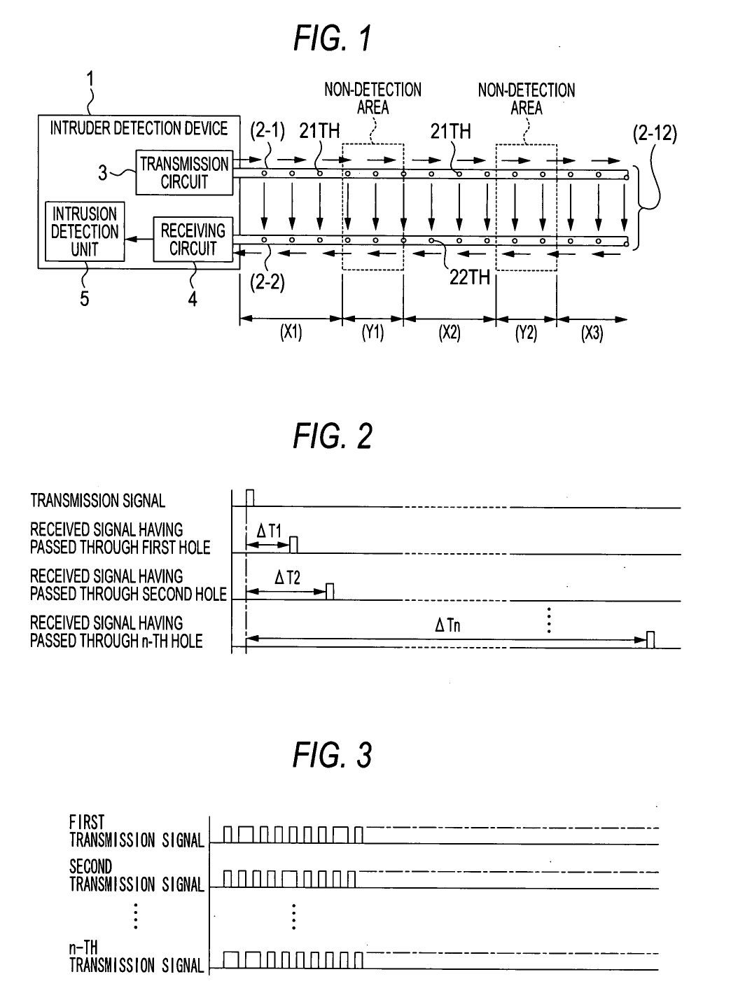

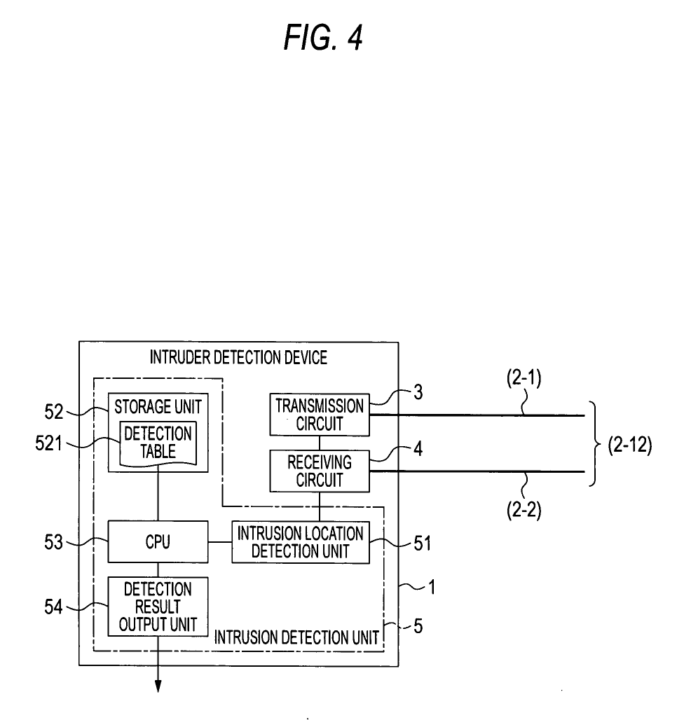

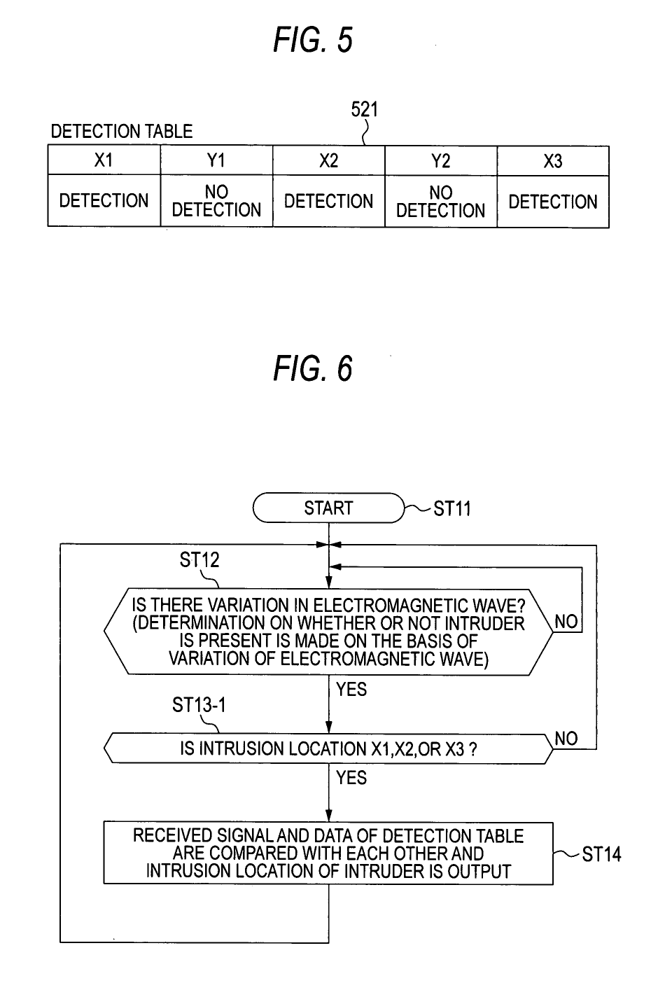

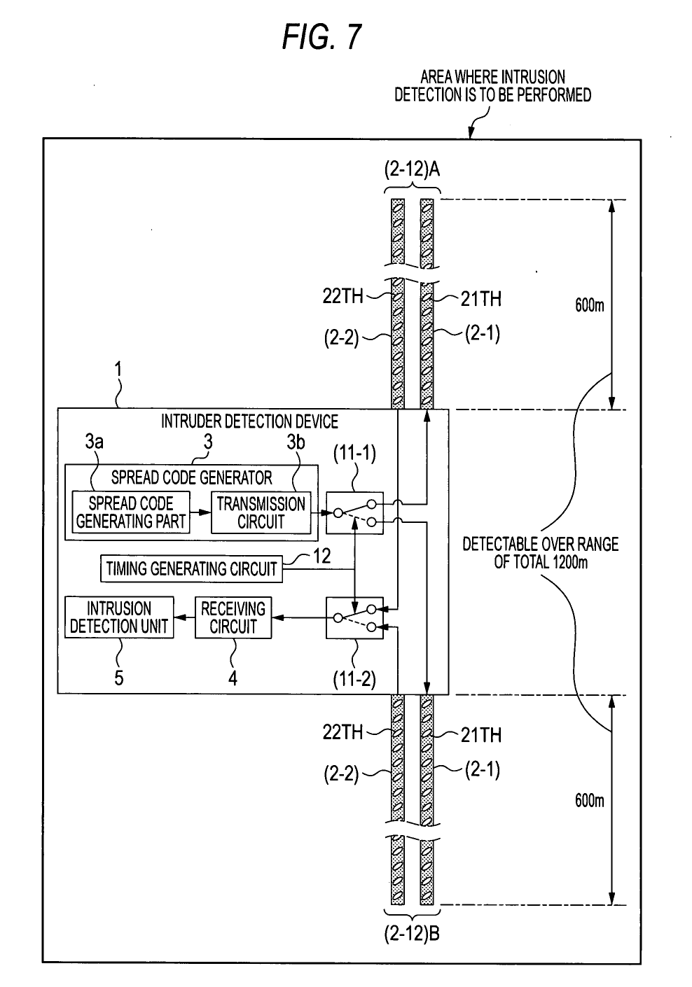

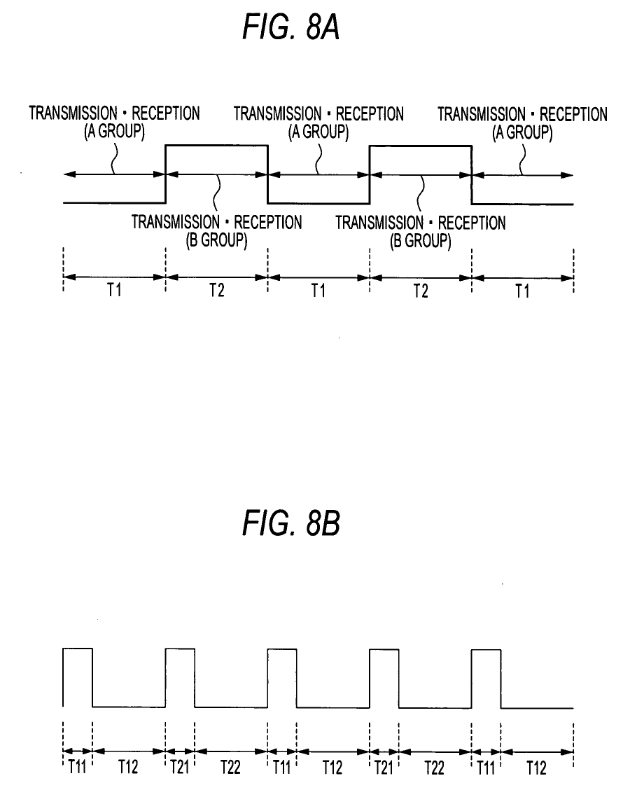

Hereinafter, a first embodiment of the invention will be described with reference to FIGS. 1 to 8. FIGS. 1 to 6 are views explaining a technique used as a basis of the entire configuration of an intruder detection system according to the first embodiment. Specifically, FIG. 1 is a view illustrating an example of the basic system configuration. FIG. 2 is a view illustrating an example of the concept of detection of the intrusion location. FIG. 3 is a view illustrating a specific example of a transmission signal. FIG. 4 is a block diagram illustrating an example of the inner configuration of an intruder detection device shown in FIG. 1. FIG. 5 is a view illustrating an example of a detection table. FIG. 6 is a view illustrating an example of an operation flow. FIG. 7 is a view illustrating an example of the entire configuration of an intruder detection system in which a plurality of leaky transmission lines are connected to an intruder detection device. FIGS. 8A and 8B are timing charts illustrating the timing alternately processed in the time division manner in order to allow signals of both an A-group leaky transmission line and a B-group leaky transmission line to be processed in the same spread code generator, receiving circuit, and intrusion detection unit.

FIG. 1 shows an intruder detection system in which an intruder detection device 1 is connected to a transmission-side leaky transmission line 2-1 and a receiving-side leaky transmission line 2-2 that is provided together with the transmission-side leaky transmission line 2-1 in order to receive a leaky electric wave from the transmission-side leaky transmission line 2-1. If an electric wave received in the receiving-side leaky transmission line 2-2 varies, the intruder detection system determines that an intruder is present. The transmission-side leaky transmission line 2-1 and the receiving-side leaky transmission line 2-2 include a plurality of leaky points 21TH, 21TH, . . . , 21TH, 22TH, 22TH, . . . , 22TH existing in the direction in which the transmission-side leaky transmission line 2-1 and the receiving-side leaky transmission line 2-2 extend. The intruder detection system includes an intrusion location detection unit 51 (refer to FIG. 4 which will be described later) that detects the intrusion location of an intruder on the basis of a state of a each signal, which is received in a receiving circuit 4 on the receiving side, affected by the leaky electric wave at each of the leaky points 21TH, 21TH, . . . , 21TH, 22TH, 22TH, . . . , 22TH. The intruder detection system further includes a detection table 521 in which a detectable intrusion location is associated with a detection area. If intrusion location detection information of the intrusion location detection unit 51 corresponds to a detection area of the detection table 521, a detection result output unit 54 (refer to FIG. 4 which will be described later) outputs a detection result.

The intruder detection device 1 includes a transmission circuit 3, the receiving circuit 4, and an intrusion detection unit 5. For example, a leaky coaxial cable that is commercially available may be used as the transmission-side leaky transmission line 2-1 and the receiving-side leaky transmission line 2-2. The leaky points 21TH, 21TH, . . . , 21TH, 22TH, 22TH, . . . , 22TH of the transmission-side leaky transmission line 2-1 and the receiving-side leaky transmission line 2-2 are penetration slots provided so as to penetrate an outer cover of the commercially-available leaky coaxial cable at predetermined distances of several tens of centimeters.

Here, an example of concept of detection of the intrusion location will be described.

In the case when the commercially-available leaky coaxial cable is used as the transmission-side leaky transmission line 2-1 and the receiving-side leaky transmission line 2-2, the transmission-side leaky transmission line 2-1 and the receiving-side leaky transmission line 2-2 are provided so as to be spaced apart from each other by several meters, and for example, one transmission pulse is transmitted from the transmission circuit 3, as shown in FIG. 2, a leaky electric wave from a first (initial) hole (penetration slot) of the transmission-side leaky transmission line 2-1 is received through a first (initial) hole (penetration slot) of the receiving-side leaky transmission line 2-2 and arrives at the receiving circuit 4 as a received signal. In this case, the arrival time of the leaky electric wave is delayed by ΔT1 from the start of transmission of the transmission signal.

In the same manner, when one transmission pulse is transmitted from the transmission circuit 3, a leaky electric wave from a second hole of the transmission-side leaky transmission line 2-1 is received through a second hole of the receiving-side leaky transmission line 2-2 and arrives at the receiving circuit 4 as a received signal, but the arrival time of the leaky electric wave is delayed by ΔT2 from the start of transmission of the transmission signal.

In the same manner, the arrival time of a received signal received through a third hole is delayed by ΔT3 from the start of transmission of the transmission signal.

If the length of a signal transmission line is known, the arrival time ΔT1, ΔT2, ΔT3, . . . , that is, the arrival time ΔT can be easily acquired by calculation since it is already known that a propagation rate of a signal is 300000 Km/sec (in the case of the air).

Therefore, by storing data of the arrival time ΔT calculated beforehand when configuring the system, the receiving circuit 4 can distinguish which hole (penetration slot) a received signal has passed through by comparing the actually received signal with the stored data.

In addition, when an intruder enters a region where the leaky electric wave exists, for example, the shape of a leaky electric wave varies due to the intruder.

Accordingly, if the intrusion detection unit 5 detects that the signal received in the receiving circuit 4 has varied, it is possible to detect in which location of the transmission-side leaky transmission line 2-1 and the receiving-side leaky transmission line 2-2 an intruder has intruded and then to report a result of the detection.

Since a signal speed is very high and a detection operation speed of the receiving circuit is related to the signal speed, a unit pulse is not actually transmitted once every few seconds as the transmission signal. For example, as shown in FIG. 3, it is possible to improve the detection accuracy by using a pseudo noise spread code called a PN code, for example, a coded signal having tens of thousands of random pulse strings. The same PN codes may be repeatedly transmitted or different PN codes may be sequentially transmitted. The PN code is a well-known code.

When the PN code is used in the intruder detection system shown in FIG. 1, the intruder detection device 1 modulates a phase of a high-frequency carrier wave using an output of the transmission circuit 3, which generates a spread code, and outputs the modulated carrier wave to the transmission-side leaky transmission line 2-1. The leaky electric wave output from the transmission-side leaky transmission line 2-1 is received through the receiving-side leaky transmission line 2-2 and is then received in the receiving circuit 4. In the receiving circuit 4, a phase operation on the received electric wave is performed using a reference spread code related to an intrusion distance and the electric field intensity is informed to the intrusion detection unit 5. The intrusion detection unit 5 performs intruder detection corresponding to the intrusion distance on the basis of variation of the electric field intensity.

The intruder detection system has the transmission-side leaky transmission line 2-1 and the receiving-side leaky transmission line 2-2, which is provided together with the transmission-side leaky transmission line 2-1 in order to receive a leaky electric wave from the transmission-side leaky transmission line 2-1, and determines that an intruder is present when an electric wave received in the receiving-side leaky transmission line 2-2 varies. A study performed by the inventors of the invention shows that each of the leaky transmission lines 2-1 and 2-2 is provided to have a length of about 600 m and it is possible to detect whether or not an intruder is present between the leaky transmission lines 2-1 and 2-2 and detect the intrusion location over a long distance of about 600 m.

If it is possible to detect whether or not an intruder is present and detect the intrusion location over a long distance of about 600 m, the intruder detection system may be applied to a factory, a transformer substation, an airport, a parking lot, and so on. However, in the case when the detection can be performed over a long distance of about 600 m, for example, a gate for the general public or a general road may exist in a detection region that is about 600 m long. In this case, it is necessary to design the intruder detection system such that a person passing through the gate for the general public or the general road is not regarded as an intruder by setting a non-detection region. For example, even if the leaky electric wave is disturbed due to a person passing through the gate for the general public or the general road, and accordingly, a received signal varies, it is necessary to perform processing for not regarding the person passing through the gate for the general public or the general road as an intruder.

Therefore, in the technique that is a basis of the first embodiment of the invention, as shown in FIG. 4, the intrusion detection unit 5 of the intruder detection device 1 includes a storage unit 52, which stores a detection table 521 in which a non-detection area can be set, in addition to the intrusion location detection unit 51. A CPU 53 compares information of the intrusion location detected by the intrusion location detection unit 51 with information set beforehand in the detection table 521. If the information of the intrusion location detected by the intrusion location detection unit 51 does not correspond to a detection region set in the detection table 521, a detection result output unit 54 does not output the detection result.

A specific example of the detection table 521 is shown in FIG. 5.

In FIGS. 1 and 5, reference numerals X1, X2, and X3 denote a desired detection region (location) where it is necessary to detect an intruder, and reference numerals Y1 and Y2 denote a non-detection region (location) in which it is not necessary to detect an intruder. In the detection table 521 shown in FIG. 5, the detectable intrusion locations X1, X2, X3, Y1, and Y2 are associated with a detection area and a non-detection area, respectively.

When intrusion location detection information in the intrusion location detection unit 51 corresponds to a detection area of the detection table 521, a detection result is output from the detection result output unit 54. When the intrusion location detection information in the intrusion location detection unit 51 corresponds to a non-detection area of the detection table 521, the detection result is not output from the detection result output unit 54.

Next, referring to FIGS. 1 and 4, an operation based on an operation flow chart shown in FIG. 6 will be explained.

If an intruder enters between the leaky transmission lines 2-1 and 2-2 shown in FIG. 1, the intruder detection device 1 determines whether or not there is a variation in electromagnetic wave. As a result, the intruder detection device 1 determines whether or not an intruder is present on the basis of the variation of the electromagnetic wave (step ST12 of FIG. 6).

As a result of the determination in step ST12 of FIG. 6, if the electromagnetic wave has varied (when an intruder is present), the intrusion location detection unit 51 (refer to FIG. 4) detects if the intrusion location is X1, X2, or X3 (step ST13-1).

Then, a received signal (intrusion location detection information in the intrusion location detection unit) detected in step ST13-1 is compared with data of the detection table 521. In the case of intrusion detection within the intrusion detection area, it is conclusively determined that an intruder is present and the detection result output unit 54 outputs the intrusion location of the intruder (step ST14).

In addition, in the case that the PN code is used, the detection regions X1, X2, and X3 are associated with the reference spread code. For example, the detection range X1 is a range of a predetermined reference spread code PNx1 to a predetermined reference spread code PNxx.

A phase operation on the received electric wave is performed using a predetermined reference spread code and the electric field intensity corresponding to a predetermined reference spread code is calculated. When it is determined that the electric field intensity has significantly varied, it is considered as intrusion related to the predetermined reference spread code, that is, intrusion within the detection range X1.

In the technique that is a basis of the first embodiment of the invention, as described above, the intrusion detection can be easily and precisely performed only by comparison using the detection table 521. In addition, it is possible to set the detection range and the non-detection range and to change the set detection range and the set non-detection range. In addition, it is possible to perform the intrusion detection, for example, at every 2 m or 5 m distance, over a long distance. As a result, an applicable range of the intruder detection system remarkably extends.

Next, an example of the entire configuration of the intruder detection system in which a plurality of leaky transmission lines are connected to the intruder detection device will be described with reference to FIG. 7.

The system configuration shown in FIG. 7 is characterized in that a plurality of groups of leaky transmission line pairs 2-12 (two groups of leaky transmission line pairs are exemplified in FIG. 7), such as an A-group leaky transmission line pair (2-12)A and a B-group leaky transmission line pair (2-12)B, are provided, each leaky transmission line pair 2-12 being configured to include the pair of leaky transmission lines 2-1 and 2-2.

In the example shown in FIG. 7, in order to allow the transmission circuit 3b and the receiving circuit 4 to be shared between a plurality of groups of leaky transmission line pairs 2-12 including the A-group leaky transmission line pair (2-12)A and the B-group leaky transmission line pair (2-12)B, an analog multiplexer for transmission 11-1, an analog multiplexer for reception 11-2, and a timing generating circuit 12 are provided.

The analog multiplexer for transmission 11-1 is a transmission output switching unit that receives an output of the timing generating circuit 12 and switches and supplies an output of the transmission circuit 3b to each of the plurality of groups of leaky transmission line pairs 2-12 in an alternative and sequential manner.

The analog multiplexer for reception 11-2 is a reception input switching unit that receives an output of the timing generating circuit 12 and switches and supplies a received signal of each of the plurality of groups of leaky transmission line pairs 2-12 to an input of the receiving circuit 4 in the alternative and sequential manner.

The timing generating circuit 12 is a switching operation control unit for the alternative of transmission or reception that controls a transmission and reception switching operation of each of the analog multiplexers 11-1 and 11-2 such that the analog multiplexers 11-1 and 11-2 perform switching operations in synchronization with each other in order for the transmission circuit 3b and the receiving circuit 4 to perform transmission and reception with respect to the same group of leaky transmission line pairs 2-12 and the plurality of groups of leaky transmission line pairs 2-12 are connected to the transmission circuit 3b and the receiving circuit 4 in the alternative and sequential manner.

Next, an example of an operation in the case of FIG. 7 will be described with reference to FIG. 8.

In order to process a signal of each of the A-group leaky transmission line pair (2-12)A and the B-group leaky transmission line pair (2-12)B using the same spread code generator 3, the receiving circuit 4, and the intrusion detection unit 5, the signal of each of the leaky transmission line pairs (2-12)A and (2-12)B is alternately processed in a time division manner. An example of the processing timing is shown in a timing chart of FIG. 8.

In FIG. 8A, ‘T1’ indicates a processing time for a signal of the A-group leaky transmission line pair (2-12)A, and ‘T2’ is a processing time for a signal of the B-group leaky transmission line pair (2-12)B. As shown in FIG. 8B, for example, the period T1 is divided into periods T11 and T12 and the period T2 is divided into periods T21 and T22.

For example, the period T11 is a period for which the analog multiplexers 11-1 and 11-2 perform alternative and switching operations in order to activate intrusion detection using the A-group leaky transmission line pair (2-12)A. During the period T11, a transmission signal is transmitted from the spread code generator 3 to a transmission-side transmission line 2-1 of the A-group leaky transmission line pair (2-12)A and a received signal from a receiving-side transmission line 2-2 of the A-group leaky transmission line pair (2-12)A is transmitted to the receiving circuit 4. The period T12 is a period for which the signal received during the period T11 is processed in the intrusion detection unit 5.

Similarly, the period T21 is a period for which the analog multiplexers 11-1 and 11-2 perform alternative and switching operations in order to activate intrusion detection using the B-group leaky transmission line pair (2-12)B. During the period T21, a transmission signal is transmitted from the spread code generator 3 to a transmission-side transmission line 2-1 of the B-group leaky transmission line pair (2-12)B and a received signal from a receiving-side transmission line 2-2 of the B-group leaky transmission line pair (2-12)B is transmitted to the receiving circuit 4. The period T22 is a period for which the signal received during the period T21 is processed in the intrusion detection unit 5.

As for both the A-group leaky transmission line pair (2-12)A and the B-group leaky transmission line pair (2-12)B, the detection range thereof can be set to 600 m in the same manner as in FIG. 1. Accordingly, as shown in FIG. 7, by disposing the intruder detection device 1 in the middle and providing the A-group leaky transmission line pair (2-12)A at a side (for example, north) of the intruder detection device 1 and the B-group leaky transmission line pair (2-12)B at the other side (for example, south) of the intruder detection device 1, it is possible to cover a detection range of total 1200 m. As a result, it is possible to further extend the detection range.

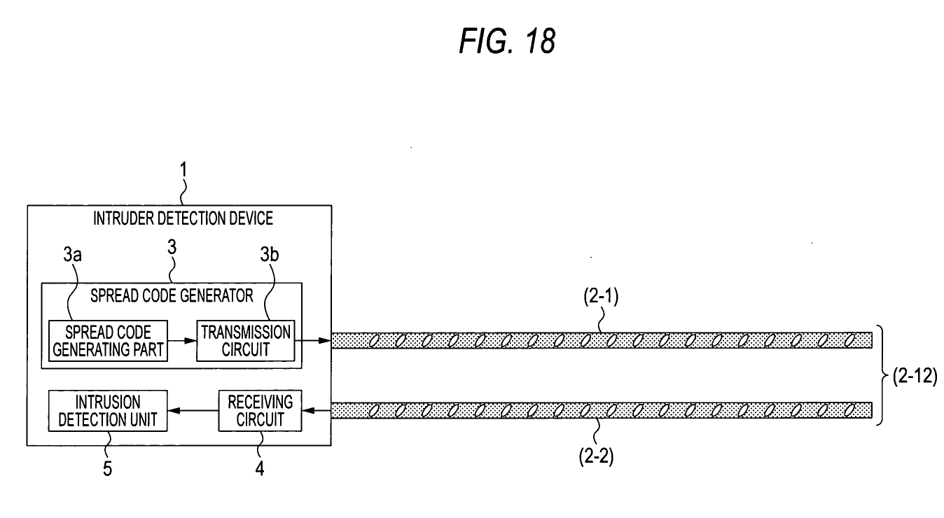

In other words, in the intruder detection system that includes: the intruder detection device 1; and the leaky transmission line pair 2-12 including the transmission-side leaky transmission line 2-1, which is connected to the intruder detection device 1 and through which a leaky electric wave is output on the basis of a carrier wave output from the intruder detection device 1, and the receiving-side leaky transmission line 2-2, which is connected to the intruder detection device 1 and through which the leaky electric wave output from the transmission-side leaky transmission line 2-1 is received, and that performs intrusion detection by causing the intruder detection device 1 to detect the variation of the leaky electric wave received through the receiving-side leaky transmission line 2-2, it is possible to further extend the detection range by providing the plurality of leaky transmission line pairs (2-12)A and (2-12)B, which are connected to the intruder detection device 1 and through which the leaky electric wave is output and received, so as to be spaced apart from each other and have a predetermined angle therebetween (180° in FIG. 7), as compared with the intruder detection system under development shown in FIG. 18.

In addition, in the case of alternately activating intrusion detection using the A-group leaky transmission line pair (2-12)A and intrusion detection using the B-group leaky transmission line pair (2-12)B as described above, interference at the time of transmission and reception between the A-group leaky transmission line pair (2-12)A and the B-group leaky transmission line pair (2-12)B may be prevented. However, strictly speaking, a signal is slightly delayed while the signal comes and goes through the transmission-side transmission line 2-1 and the receiving-side transmission line 2-2, and accordingly, it may not be necessarily said that there is no interference in the case when the periods T1 and T2 are very short. Moreover, the A-group leaky transmission line pair (2-12)A and the B-group leaky transmission line pair (2-12)B may operate at the same time. For this reason, the plurality of leaky transmission line pairs (2-12)A, (2-12)B, . . . are preferably provided to be spaced apart from each other by a distance that allows leaky electric waves not to interfere with each other from the viewpoint of preventing an error operation of intrusion detection.

### Second Embodiment

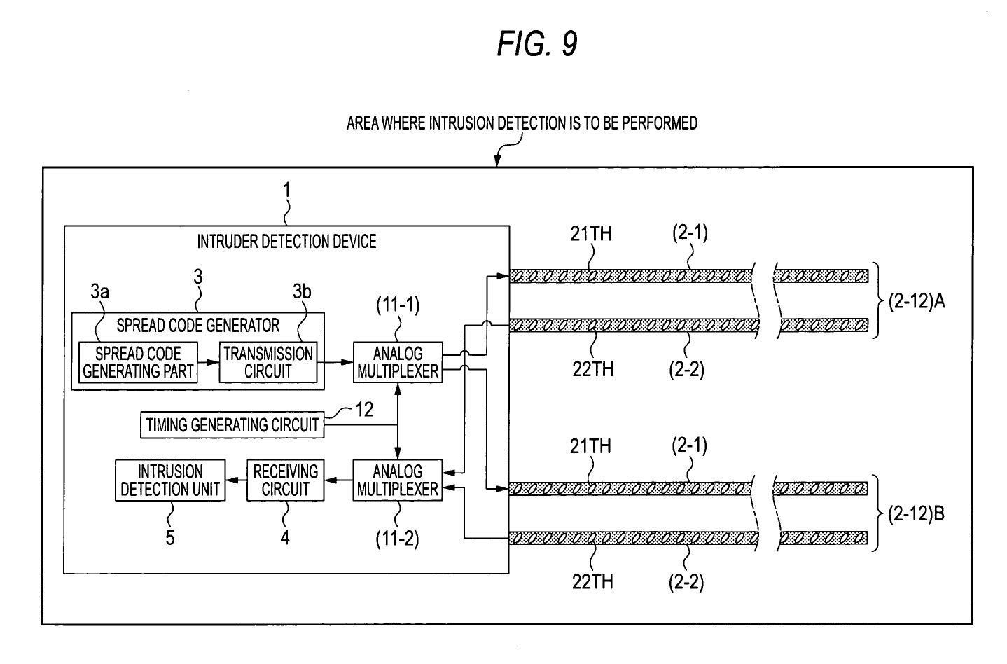

Hereinafter, referring to FIG. 9, it will be explained about another example of the entire configuration of an intruder detection system, in which a plurality of leaky transmission lines are connected to an intruder detection device, according to a second embodiment of the invention.

In the first embodiment, an example has been shown in which the intruder detection device 1 is disposed in the middle and the A-group and B-group leaky transmission line pairs each having a length of 600 m are provided in the opposite directions, such as north and south directions of the intruder detection device 1. However, the A-group and B-group leaky transmission line pairs may be provided parallel to each other according to the situation in a construction site. FIG. 9 illustrates a state described above. In FIG. 9, the same reference numerals as in FIG. 7 have the same functions. Moreover, the following description to be made referring to FIG. 9 will be focused on a point different from that described with reference to FIG. 7, and a point that is substantially the same as that described with reference to FIG. 7 will be omitted.

In the case when construction regions of the A-group and B-group leaky transmission line pairs (2-12)A and (2-12)B each having a length of 600 m extend parallel to each other with a building interposed therebetween in a predetermined yard, for example, it is possible to apply FIG. 7. Accordingly, since the detection range of total 1200 m can be covered, it is possible to further extend the detection range in the same manner as in the first embodiment described above.

In other words, in the intruder detection system that includes: the intruder detection device 1; and the leaky transmission line pair 2-12 including the transmission-side leaky transmission line 2-1, which is connected to the intruder detection device 1 and through which a leaky electric wave is output on the basis of a carrier wave output from the intruder detection device 1, and the receiving-side leaky transmission line 2-2, which is connected to the intruder detection device 1 and through which the leaky electric wave output from the transmission-side leaky transmission line 2-1 is received, and that performs intrusion detection by causing the intruder detection device 1 to detect the variation of the leaky electric wave received through the receiving-side leaky transmission line 2-2, it is possible to further extend the detection range by providing the plurality of leaky transmission line pairs (2-12)A and (2-12)B, which are connected to the intruder detection device 1 and through which the leaky electric wave is output and received, so as to be spaced apart from each other and have a predetermined angle therebetween (0° in FIG. 9) as compared with the intruder detection system under development shown in FIG. 18.

### Third Embodiment

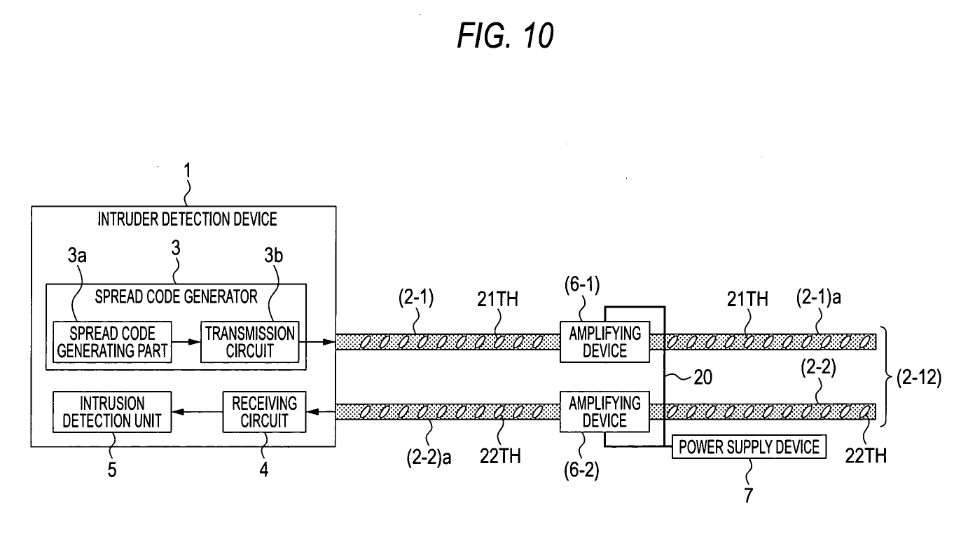

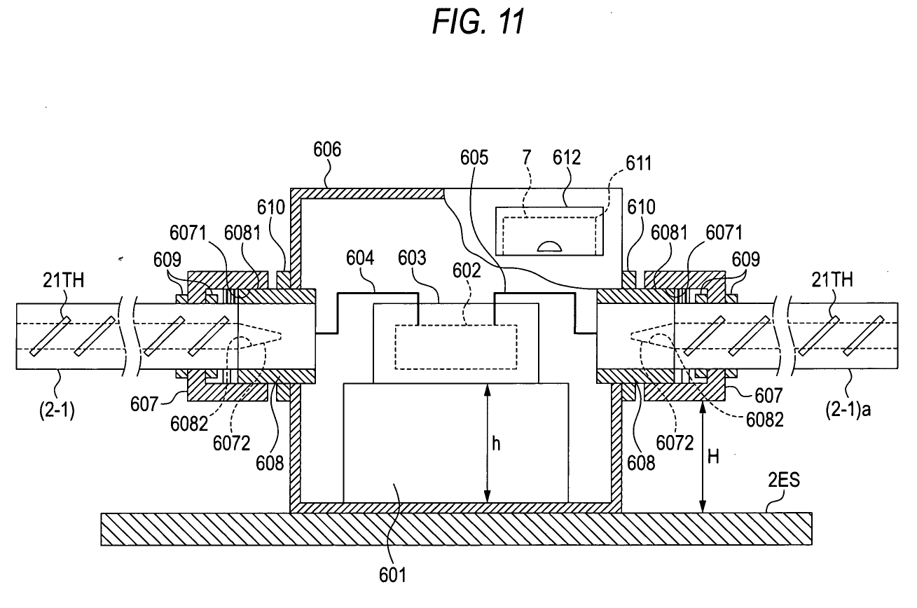

Hereinafter, a third embodiment of the invention will be described with reference to FIGS. 10 and 11. FIG. 10 is a view illustrating an example in which a transmission-side leaky transmission line and a receiving-side leaky transmission line each is configured to include a plurality of transmission lines. FIG. 11 is a longitudinal sectional view illustrating a part of the detailed structure of an amplifying device shown in FIG. 10.

In FIGS. 7 and 9, the configuration in which the plurality of leaky transmission line pairs (2-12)A, (2-12)B, . . . are connected to the intruder detection device has been exemplified. However, in the third embodiment, as shown in FIG. 10, an amplifying device 6 is added in the configuration of the intruder detection system shown in FIG. 18 in order to extend the distance in the direction in which the leaky transmission line pair 2-12 extends, such that it becomes possible to extend a detection range in the direction in which the leaky transmission line pair 2-12 extends.

Further, in the present embodiment, a basic operation of an intruder detection system using the leaky transmission line pair 2-12 is the same as that in the first embodiment, and accordingly, a different point from the first embodiment will now be described.

Specifically, as shown in FIG. 10, a transmission-side leaky transmission line (2-1)a is connected to the transmission-side leaky transmission line 2-1 of the leaky transmission line pair 2-12 with an amplifying device 6-1 interposed therebetween, and a receiving-side leaky transmission line (2-2)a is connected to the receiving-side leaky transmission line 2-2 of the leaky transmission line pair 2-12 with an amplifying device 6-2 interposed therebetween. In addition, a power supply device 7 that supplies power to the amplifying device 6-1 and the amplifying device 6-2 is provided.

Here, since an electric wave flowing through the transmission-side leaky transmission line 2-1 and the receiving-side leaky transmission line 2-2 is attenuated as the position is far from the intruder detection device 1 (that is, as the position is closer to a downstream side), it is not possible to set the detection range above a predetermined distance. However, using the configuration in which the amplifying devices 6-1 and 6-2 are connected to amplify an attenuated electric wave and the attenuated electric wave flows to the transmission-side leaky transmission line (2-1)a and the receiving-side leaky transmission line (2-2)a at the downstream side, it is possible to extend the detection distance in the direction in which the leaky transmission line pair 2-12 extends.

In order to cause an amplifier circuit 602 (refer to FIG. 11) within each of the amplifying devices 6-1 and 6-2 to operate, power is supplied from the power supply device 7 having a battery to the amplifying devices 6-1 and 6-2 through a power line 20.

FIG. 11 is a view illustrating the detailed structure of the amplifying device 6-1 of the transmission-side leaky transmission line 2-1. Referring to FIG. 11, an amplifier-circuit-mounted board 603, in which the amplifier circuit 602 is mounted, is attached on a mount 601, an input side of the amplifier circuit 602 is connected to a downstream end of the transmission-side leaky transmission line 2-1, which is located at the upstream side of the amplifying device 6-1, through a connection line 604, and an output side of the amplifier circuit 602 is connected to an upstream end of the transmission-side leaky transmission line (2-l)a, which is located at the downstream side of the amplifying device 6-1, through a connection line 605. Since the amplifier-circuit-mounted board 603, in which the amplifier circuit 602 is mounted, is attached on the mount 601, the amplifier-circuit-mounted board 603 is positioned at a predetermined height h from a transmission line providing surface 2ES.

The mount 601, the amplifier circuit 602, the amplifier-circuit-mounted board 603, the connection line 604, and the connection line 605 are all covered by a watertight hollow box 606 made of a conductive material, such as aluminum, such that leakage of an electromagnetic wave from the amplifier circuit 602, the connection line 604, and the connection line 605 is prevented due to the watertight hollow box 606.

Connections between the watertight hollow box 606 and the transmission-side leaky transmission lines 2-1 and (2-1)a formed of leaky coaxial cables are made by fastening a transmission-line-side conductive connector member 607 and a box-side conductive connector member 608 each other by screws 6071 and 6081 thereof such that the transmission-line-side conductive connector member 607 and the box-side conductive connector member 608 come in contact with each other by pressure.

The transmission-line-side connector member 607 is provided with a tapered connection pin (core of the leaky coaxial cable) 6072 and the box-side connector member 608 is provided with a tapered connection pin receiving hole 6082. By fastening the transmission-line-side connector member 607 and the box-side connector member 608 each other by the screws 6071 and 6081 thereof, the pressure contact using the connection pin 6072 and the connection pin receiving hole 6082 is more reliably realized.

The transmission-line-side connector member 607 is fixed to each of the leaky transmission line 2-1 and (2-1)a by attaching a connector fixing member 609 to each of the leaky transmission lines 2-1 and (2-1)a.

In addition, the box-side connector member 608 is fixed to the watertight hollow box 606 using a box-side connector mounting flange 610 attached to the watertight hollow box 606.

In this manner, both the leaky transmission lines 2-1 and (2-1)a formed of coaxial cables are connected to the watertight hollow box 606.

The connection pin receiving hole 6082 located at the side of the leaky transmission line 2-1 is connected to the connection line 604 and the connection pin receiving hole 6082 located at the side of the leaky transmission line (2-1)a is connected to the connection line 605. A signal of the leaky transmission line 2-1 arrives at the amplifier circuit 602 on the amplifier-circuit-mounted board 603 through the connection line 604 and is then amplified in the amplifier circuit 602. The signal amplified in the amplifier circuit 602 is transmitted from the connection pin receiving hole 6082 to the leaky transmission line (2-1)a through the connection line 605.

The transmission-line-side connector member 607 and the box-side connector member 608, which are located at the upstream leaky transmission line 2-1 side, and a structure of the periphery thereof are equal to the transmission-line-side connector member 607 and the box-side connector member 608, which are located at the downstream leaky transmission line (2-1)a side, and a structure of the periphery thereof.

The power for the amplifier-circuit-mounted board 603 is supplied from the battery 7 housed in a battery housing room 611 provided on a side surface of the watertight hollow box 606. The battery 7 is equivalent to a battery of the power supply device 7 shown in FIG. 10.

Since the amplifying devices 6-1 and 6-2 may be provided at the outside and may be used for a long time, it is preferable to take measures to prevent the amplifying devices 6-1 and 6-2 from being submerged due to rainwater or the like even if the amplifying devices 6-1 and 6-2 are housed within the watertight hollow box 606. For this reason, the amplifier-circuit-mounted board 603 within the watertight hollow box 606 provided on the transmission line providing surface 2ES is placed on the amplifier-circuit-mounted board mount 601 so as to be positioned at the predetermined height h from the transmission line providing surface 2ES, such that it is prevented that the amplifier circuit 602 is submerged due to water flooding into the box. In addition, the predetermined height h may be set beforehand depending on the amount of rainwater gathered and the rain flow rate, which varies according to geographic features of a place where the amplifying devices 6-1 and 6-2 are placed, weather, a drain environment, and the like. Moreover, even in a region where there is a small amount of rain, it is preferable to set the predetermined height h in consideration of accumulation of dew condensation water generated due to a temperature difference.

Similarly, the box-side connector member 608 is also provided to be spaced apart from the transmission line providing surface 2ES. As a result, a lower surface of the transmission-line-side connector member 607 is positioned at a height H from the transmission line providing surface 2ES, and thus flooding of rainwater and the like through the screws 6071 and 6081, which serve to combine the transmission-line-side connector member-607 and the box-side connector member 608, is prevented.

In addition, even though the detailed structure of the amplifying device 6-2 of the receiving-side leaky transmission line 2-2 is not shown, the detailed structure of the amplifying device 6-2 of the receiving-side leaky transmission line 2-2 is the same as that of the amplifying device 6-1 of the transmission-side leaky transmission line 2-1.

Thus, in the third embodiment, it is possible to realize an environment-proof intruder detection system, which uses a leaky transmission line allowing the detection range to extend, using the configuration in which each of the amplifying devices 6-1 and 6-2 is connected in consideration of the installation environment.

### Fourth Embodiment

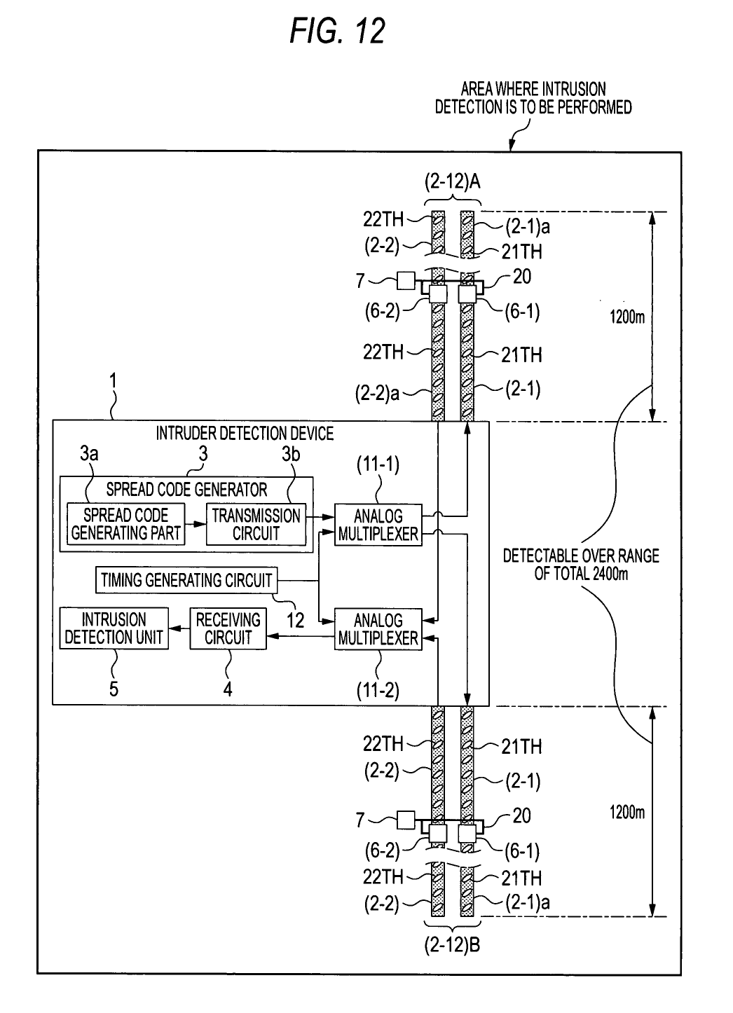

Hereinafter, referring to FIG. 12, a fourth embodiment of the invention will be described by way of an example in which a plurality of leaky transmission line pairs are connected to an intruder detection device and a transmission-side leaky transmission line and a receiving-side leaky transmission line of each leaky transmission line pair are configured to include a plurality of transmission lines, respectively.

The fourth embodiment is realized by combination of the invention in the first embodiment (refer to FIG. 7) and the invention in the third embodiment (FIG. 10), and the configuration and a function thereof are the same as those in the first and third embodiments. That is, a plurality of groups of leaky transmission line pairs 2-12 (two groups of leaky transmission line pairs are shown in FIG. 12), such as an A-group leaky transmission line pair (2-12)A and a B-group leaky transmission line pair (2-12)B, are provided, each leaky transmission line pair 2-12 being configured to include the pair of leaky transmission lines 2-1 and 2-2. In addition, a transmission-side leaky transmission line (2-1)a is connected to a downstream side of a transmission-side leaky transmission line 2-1 of each of the leaky transmission line pairs (2-12)A and (2-12)B with an amplifying device 6-1 interposed therebetween and a receiving-side leaky transmission line (2-2)a is connected to a downstream side of a receiving-side leaky transmission-line 2-2 of each of the leaky transmission line pairs (2-12)A and (2-12)B with an amplifying device 6-2 interposed therebetween. In addition, a power supply device 7 that supplies power to the amplifying devices 6-1 and 6-2 is also provided.

As described above, the configuration according to the fourth embodiment is obtained by combination of the configuration according to the first embodiment (refer to FIG. 7) of the invention and the configuration according to the third embodiment (refer to FIG. 10) of the invention. Therefore, even though each of the A-group leaky transmission line pair (2-12)A and the B-group leaky transmission line pair (2-12)B is limited not to exceed 600 m in the first embodiment described with reference to FIG. 7, each of the A-group leaky transmission line pair (2-12)A and the B-group leaky transmission line pair (2-12)B can extend up to 1200 m and the intrusion detection can be performed over a range of total 2400 m in the fourth embodiment.

### Fifth Embodiment

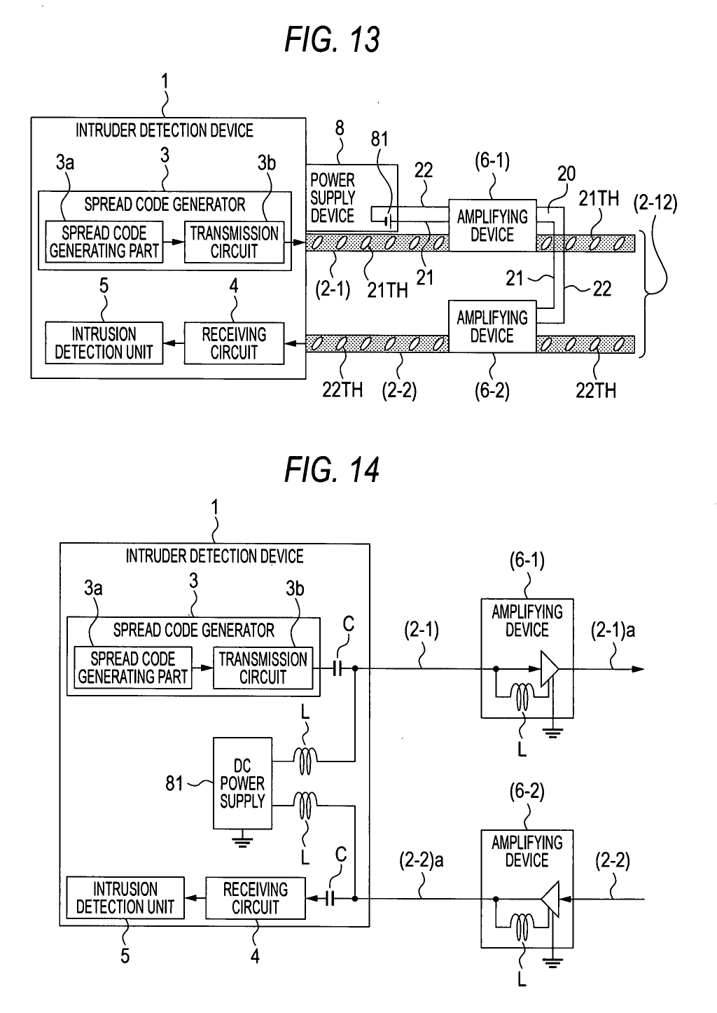

Hereinafter, referring to FIG. 13, a fifth embodiment of the invention will be described by way of another example in which a transmission-side leaky transmission line and a receiving-side leaky transmission line each is configured to include a plurality of transmission lines, and in particular, an example in which power is supplied from an intruder detection device to an amplifying device.

In the third embodiment described above, the intruder detection system in which the power supply device 7 using a battery is provided for the amplifying device 6-1 has been exemplified (refer to FIGS. 10 and 11).

In the fifth embodiment, as shown in FIG. 13, a power supply device 8 having a DC power supply 81 for operating the amplifying devices 6-1 and 6-2 is provided in the intruder detection device 1 or in the vicinity of the intruder detection device 1.

A power line 20 through which power from the DC power supply 81 is supplied to the amplifying devices 6-1 and 6-2 includes a ‘+’ power line 21 and a ‘−’ power line 22, and the ‘+’ power line 21 and the ‘−’ power line 22 are provided along a transmission line, such as the transmission-side transmission line 2-1 and the receiving-side transmission line 2-2. In the present embodiment, a case in which the ‘+’ power line 21 and the ‘−’ power line 22 are provided along the transmission-side transmission line 2-1 will be described.

In addition, a dry-cell battery, a solar battery, a DC power supply that supplies DC power obtained by AC/DC conversion, or the like may be used as the DC power supply 81.

Thus, according to the present embodiment, since power can be supplied to the amplifying device in a state in which the power supply device 8 is provided in the intruder detection device 1, concentration of facilities is realized. Accordingly, unlike the third embodiment described above, it is not necessary to take pains to go out to a place where the amplifying devices 6-1 and 6-2 are provided for the purpose of maintenance check of the power supply device 7 using a battery.

### Sixth Embodiment

Hereinafter, referring to FIG. 14, a sixth embodiment of the invention will be described by way of still another example in which a transmission-side leaky transmission line and a receiving-side leaky transmission line each is configured to include a plurality of transmission lines, and in particular, another example in which power is supplied from an intruder detection device to an amplifying device.

In the fifth embodiment (refer to FIG. 13), as described above, the case in which the ‘+’ power line 21 and the ‘−’ power line 22 are provided along a transmission line, such as the transmission-side transmission line 2-1 and the receiving-side transmission line 2-2, has been exemplified. However, in the sixth embodiment, a case in which the transmission-side transmission line 2-1 and the receiving-side transmission line 2-2 are used as power lines will be described.

In the present embodiment, a high-frequency resistor L, such as a coil, having high resistance with respect to a high frequency and low resistance with respect to a DC current is provided between a DC power supply 81 and a connection point 82 between the DC power supply 81 and the transmission-side transmission line 2-1 such that a high-frequency output signal of the transmission circuit 3b does not flow to the DC power supply 81 and provided between the DC power supply 81 and a connection point 83 between the DC power supply 81 and the receiving-side transmission line 2-2 such that a high-frequency received signal does not flow to the DC power supply 81. In addition, in the present embodiment, a DC resistor C, such as a capacitor, having low resistance with respect to a high frequency and high resistance with respect to a DC current is provided between the connection point 82 and the transmission circuit 3b and between the connection point 83 and the receiving circuit 4 such that an output of the DC power supply 81 is not supplied to the transmission circuit 3b and the receiving circuit 4.

According to the present embodiment, unlike the fifth embodiment (refer to FIG. 13) described above, it is not necessary to provide the ‘+’ power line 21 and the ‘−’ power line 22.

### Seventh Embodiment

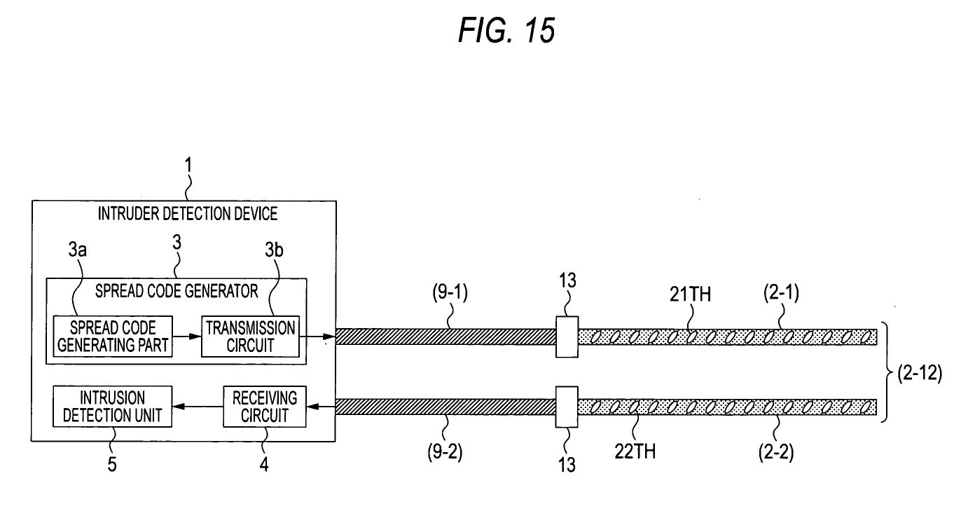

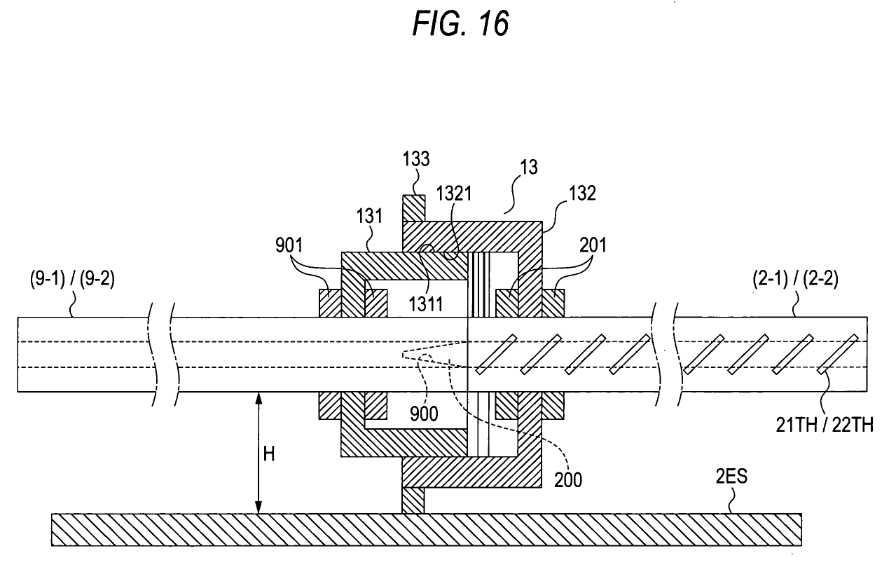

Hereinafter, a seventh embodiment of the invention will be described with reference to FIGS. 15 and 16. FIG. 15 is a view illustrating still another example in which a transmission-side leaky transmission line and a receiving-side leaky transmission line each is configured to include a plurality of transmission lines, and in particular, an example in which a non-leaky transmission line is connected at the upstream side. FIG. 16 is a longitudinal sectional view illustrating a part of the detailed structure in which each of a plurality of transmission lines shown in FIG. 15 is connected.

The seventh embodiment may be applied to a case in which a detection area is far from the intruder detection device 1. That is, in the seventh embodiment, a transmission-side non-leaky transmission line 9-1 formed of, for example, a coaxial cable and a receiving-side non-leaky transmission line 9-2 formed of, for example, a coaxial cable are used in the configuration of the intruder detection system shown in FIG. 18 in order to extend a distance up to a detection area far from the intruder detection device 1, such that it becomes possible to provide the transmission-side leaky transmission line 2-1 and the receiving-side leaky transmission line 2-2 at the position far from the intruder detection device 1. Thus, according to the seventh embodiment, a detection range can be extended.

Specifically, in the present embodiment, the transmission-side non-leaky transmission line 9-1 that serves to transmit an output of the transmission circuit 3b to the transmission-side leaky transmission line 2-1 in a non-leaky manner is connected between the transmission circuit 3b of the intruder detection device 1 and the transmission-side leaky transmission line 2-1, and the receiving-side non-leaky transmission line 9-2 that serves to transmit a received signal, which is received by the receiving-side leaky transmission line 2-2, to the receiving circuit 4 in a non-leaky manner is connected between the receiving circuit 4 of the intruder detection device 1 and the receiving-side leaky transmission line 2-2.

Connection between the transmission-side non-leaky transmission line 9-1 and the transmission-side leaky transmission line 2-1 and connection between the receiving-side non-leaky transmission line 9-2 and the receiving-side leaky transmission line 2-2 are performed using a connector 13, respectively. The specific structure of the connector 13 is shown in FIG. 16, and an explanation thereof will be made later.

Referring to FIG. 15, a signal output from the transmission circuit 3b is transmitted through the transmission-side non-leaky transmission line 9-1 and then arrives at the transmission-side leaky transmission line 2-1 through the transmission-side connector 13. An electric wave received in the receiving-side leaky transmission line 2-2 is transmitted to the receiving-side non-leaky transmission line 9-2 through the receiving-side connector 13 and then arrives at the receiving circuit 4.

The basic configuration of the connector 13 is the same as that of the transmission-line-side connector member 607 shown in FIG. 11 and will be described below with reference to FIG. 16.

Connection between the leaky transmission line 2-1 (or 2-2) formed of a leaky coaxial cable and the transmission-side non-leaky transmission line 9-1 (or 9-2) formed of a non-leaky coaxial cable is made by fastening a transmission-line-side conductive and non-leaky connector member 131 and a transmission-line-side conductive and leaky connector member 132 each other by screws 1311 and 1321 thereof such that the leaky transmission line 2-1 (or 2-2) and the non-leaky transmission line 9-1 (or 9-2) come in contact with each other by pressure.

A tapered connection pin 200 is provided on a core (core of the leaky coaxial cable) of the leaky transmission line 2-1 (or 2-2) and a tapered connection pin receiving hole 900 is provided on the non-leaky transmission line 9-1 (or 9-2). By fastening the transmission-line-side non-leaky connector member 131 and the transmission-line-side leaky connector member 132 each other by the screws 1311 and 1321 thereof, the pressure contact using the connection pin 200 and the connection pin receiving hole 900 is more reliably realized.

The transmission-line-side non-leaky connector member 131 is fixed to the non-leaky transmission line 9-1 (or 9-2) by providing a connector fixing member 901 in the non-leaky transmission line 9-1 (or 9-2).

In addition, the transmission-line-side leaky connector member 132 is fixed to the leaky transmission line 2-1 (or 2-2) by providing a connector fixing member 201 in the leaky transmission line 2-1 (or 2-2).

In the same manner as in the third embodiment described above, in order to prevent submergence due to rainwater or the like, a reinforcing flange 133 is attached to the transmission-line-side leaky connector member 132 to secure a height H.

As described above, even though the basic operation in the present embodiment is the same as that described with reference to FIG. 18, the non-leaky transmission lines 9-1 and 9-2 have only a signal transmission function required to dispose the leaky transmission lines 2-1 and 2-2 at distant places but do not serve to transmit and receive an electric wave unlike the leaky transmission lines 2-1 and 2-2.

Moreover, in the seventh embodiment described above, it is possible to obtain an intruder detection system, in which the leaky transmission lines 2-1 and 2-2 are used, capable of extending the detection range even if each of the non-leaky transmission lines 9-1 and 9-2 is connected.

### Eighth Embodiment

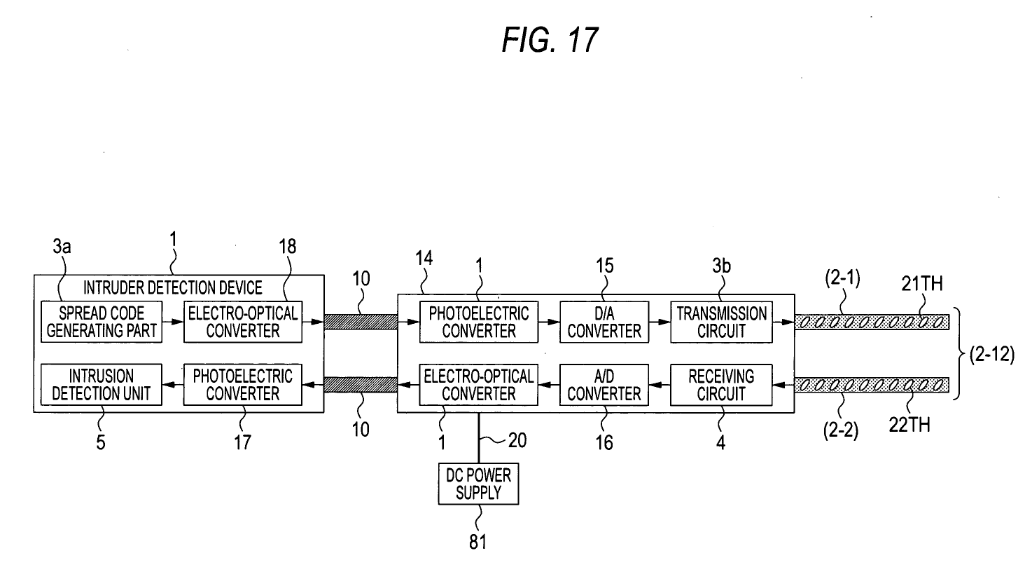

Hereinafter, referring to FIG. 17, an eighth embodiment of the invention will be described by way of still another example in which a transmission-side leaky transmission line and a receiving-side leaky transmission line each is configured to include a plurality of transmission lines, and in particular, another example in which a non-leaky transmission line is connected at the upstream side.

In the seventh embodiment, there has been described about the configuration in which the detection range is extended using the non-leaky transmission lines 9-1 and 9-2 formed of a coaxial cable. However, in the eighth embodiment, as shown in FIG. 17, an example will be described in which the detection range is extended using a transmission-side optical cable 10-1 and a receiving-side optical cable 10-2 as non-leaky transmission lines.

Signals to be transmitted through the optical cables 10-1 and 10-2 should be digital signals. Accordingly, unlike the first to sixth embodiments described with reference to FIGS. 1 to 14, the transmission circuit 3b and the receiving circuit 4 of the intruder detection device 1 are provided within a repeater 14. In addition, a digital signal between the spread code generating part 3a and the transmission circuit 3b and a digital signal between the receiving circuit 4 and the intrusion detection unit 5 are transmitted through the optical cables 10-1 and 10-2, respectively.

An operation of the intruder detection device 1 is the same as those in the first to sixth embodiments described above. Here, the optical cables 10-1 and 10-2 have only a signal transmission function required to dispose the leaky transmission lines 2-1 and 2-2 at distant places but do not serve to transmit and receive an electric wave unlike the leaky transmission lines 2-1 and 2-2.

Each of the intruder detection device 1 and the repeater 14 includes a photoelectric converter 17 and an electro-optical converter 18 that are positioned at an end thereof connected to an optical cable. Furthermore, the repeater 14 includes a D/A converter 15, which converts a digital signal of the optical cable 10-1 into an analog signal to be transmitted to the transmission-side leaky transmission line 2-1, and an A/D converter 16, which converts a received analog signal of the receiving-side leaky transmission line 2-2 into a digital signal to be transmitted to the optical cable 10-2.

In addition, power of the repeater 14 is supplied from the DC power supply 81 through a power line 20.

In the present embodiment, it is possible to provide the leaky transmission lines 2-1 and 2-2 at the intrusion detection area far from the intruder detection device 1 by using a configuration in which an optical cable is connected. As a result, it is possible to acquire an intruder detection system capable of extending the detection range.

Moreover, in FIGS. 1 to 18, like reference numerals refer to like parts or equivalent parts. In addition, in the second to eighth embodiments, explanations on-reference numerals, which have been already explained, are omitted and only main parts in each of the second to eighth embodiments have been explained.

Various modifications and alterations of this invention will be apparent to those skilled in the art without departing from the scope and spirit of this invention, and it should be understood that this is not limited to the illustrative embodiments set forth herein.

What is claimed is:

1. An intruder detection system comprising:
an intruder detection device; and
a leaky transmission line pair including a transmission-side leaky transmission line, which is connected to the intruder detection device and through which a leaky electric wave is output on the basis of an output from the intruder detection device, and a receiving-side leaky transmission line, which is connected to the intruder detection device and through which the leaky electric wave output from the transmission-side leaky transmission line is received,
wherein intrusion detection is performed by causing the intruder detection device to detect a variation of the leaky electric wave received through the receiving-side leaky transmission line, and
a plurality of leaky transmission line pairs, which are connected to the intruder detection device and through which the leaky electric wave is output and received, are provided to be spaced apart from each other.

2. The intruder detection system according to claim 1,
wherein the leaky transmission line pairs are spaced apart from each other by a distance that allows leaky electric waves transmitted through the leaky transmission line pairs not to interfere with each other.

3. The intruder detection system according to claim 1,
wherein each of the transmission-side leaky transmission line and the receiving-side leaky transmission line of at least one of the plurality of leaky transmission line pairs is configured to include a plurality of transmission lines.

4. An intruder detection system comprising:
an intruder detection device; and
a leaky transmission line pair including a transmission-side leaky transmission line, which is connected to the intruder detection device and through which a leaky electric wave is output on the basis of an output signal from the intruder detection device, and a receiving-side leaky transmission line, which is connected to the intruder detection device and through which the leaky electric wave output from the transmission-side leaky transmission line is received,
wherein intrusion detection is performed by causing the intruder detection device to detect a variation of the leaky electric wave received through the receiving-side leaky transmission line, and
each of the transmission-side leaky transmission line and the receiving-side leaky transmission line is configured to include a plurality of transmission lines.

5. The intruder detection system according to claim 3,
wherein all of the plurality of transmission lines are leaky transmission lines.

6. The intruder detection system according to claim 4,
wherein all of the plurality of transmission lines are leaky transmission lines.

7. The intruder detection system according to claim 5,
wherein a signal of a downstream end of an upstream-side leaky transmission line among the plurality of leaky transmission lines is amplified in an amplifier circuit and is then output to an upstream end of a downstream-side leaky transmission line.

8. The intruder detection system according to claim 6,
wherein a signal of a downstream end of an upstream-side leaky transmission line among the plurality of leaky transmission lines is amplified in an amplifier circuit and is then output to an upstream end of a downstream-side leaky transmission line.

9. The intruder detection system according to claim 7,
wherein the amplifier circuit is provided in a hollow box so as to be positioned at a predetermined height from a surface on which the leaky transmission lines are provided.

10. The intruder detection system according to claim 8,
wherein the amplifier circuit is provided in a hollow box so as to be positioned at a predetermined height from a surface on which the leaky transmission lines are provided.

11. The intruder detection system according to claim 9,
wherein a power supply of the amplifier circuit is detachably provided in the hollow box.

12. The intruder detection system according to claim 10,
wherein a power supply of the amplifier circuit is detachably provided in the hollow box.

13. The intruder detection system according to claim 7,
wherein power of the amplifier circuit is supplied from a side of the intruder detection device.

14. The intruder detection system according to claim 8,
wherein power of the amplifier circuit is supplied from a side of the intruder detection device.

15. The intruder detection system according to claim 3,
wherein, among the plurality of transmission lines, a transmission line close to the intruder detection device is a non-leaky transmission line.

16. The intruder detection system according to claim 4,
wherein, among the plurality of transmission lines, a transmission line close to the intruder detection device is a non-leaky transmission line.

17. The intruder detection system according to claim 15,
wherein the non-leaky transmission line is a coaxial cable.

18. The intruder detection system according to claim 16,
wherein the non-leaky transmission line is a coaxial cable.

19. The intruder detection system according to claim 17,
wherein the non-leaky transmission line is an optical cable.

20. The intruder detection system according to claim 18,
wherein the non-leaky transmission line is an optical cable.
